(19) United States
(12) Patent Application Publication
(10) Pub. No.: US 2008/0083857 A1
(43) Pub. Date: Apr. 10, 2008

(54) Cup holder

(75) Inventor: Masakatsu Kato, Hachioji-shi (JP)

Correspondence Address: KANESAKA BERNER AND PARTNERS LLP, 1700 DIAGONAL RD, SUITE 310, ALEXANDRIA, VA, 22314-2848, US

(73) Assignee: NIFCO INC., Yokohama-shi (JP)

(21) Appl. No.: 11/905,784

(22) Filed: Oct. 4, 2007

Related U.S. Application Data
(60) Provisional application No. 60/849,465, filed on Oct. 5, 2006.

(51) Int. Cl. B60N 3/10; B60R 7/04

(52) U.S. Cl. 248/149; 224/400

(57) ABSTRACT

Beverage containers can be stably held by operation of a knob even if the containers have different outer diameters. A cup holder includes a holding part provided in an opening of a box-like part having a top side opened and holding a container so as to sandwich between an inner wall surface of the box-like part and the holding part, and an auxiliary plate disposed on the holding part for changing the holding surface to project/withdraw a corresponding part from/into a holding surface side of the holding part by rotational operation through the knob. The auxiliary plate projects a corresponding part from only the holding surface on one side of the holding part by rotational operation of the knob in one direction, and projects the corresponding parts from the holding surfaces on both sides of the holding part by rotational operation of the knob in the other direction.

### BACKGROUND OF THE INVENTION AND RELATED ART STATEMENT

The present invention relates to a cup holder that is provided inside a vehicle compartment, or the like, and holds a beverage container such as a can or a cup in a manner so that it does not topple over.

As a cup holder, there is one, as shown in Patent Document 1, comprising a holding part, which is provided in an opening of a box-like part having the top side opened and holds a beverage container in a manner so as to sandwich it between inner wall surfaces of the box-like part, and an auxiliary plate for changing the holding surface, which is disposed on the holding part and can project/withdraw a corresponding part from/into the holding surface side of the holding part by rotational operation by means of a knob. That is, the holding part is placed to be fitted together so that the left and right end parts slide freely in guide grooves provided on opposite side parts of the box-like part. There are formed concave holding surfaces, which respectively hold beverage containers between front and back inner wall surfaces of the holding part. Also, the auxiliary plate is switched by rotational operation of the knob to a stored state being withdrawn inside the holding part and an in-use state respectively projecting the corresponding parts from the holding surfaces on both sides of the holding part. Therefore, in case of holding beverage containers having large diameter, the user puts the auxiliary plate into the stored state and the space between the holding surfaces of the holding part and the corresponding inner wall surfaces of the box-like part is widened. Conversely, in the case of holding beverage containers having small diameter, the user switches the auxiliary plate to the in-use state, and said space is narrowed by an amount corresponding to the projected part of the auxiliary plate. With this structure, even if the size (outer diameter) of the beverage containers is different, it can be held in a more stable state by a simple operation.

Patent Document 1: Japanese Patent No. 3461248

With the above-noted conventional structure, because the corresponding parts of the auxiliary plate are always projected/withdrawn from/into the holding surfaces on both sides of the holding part by rotational operation of the knob, there is no problem if the beverage containers both have the same outer diameter, but in the case of wanting to hold simultaneously a large-diameter container and a small-diameter container, the small-diameter container is placed to have a gap and it can no longer be held stably. Therefore, the purpose of the present invention is to make the holder such that each container can be held in a more stable state by rotational operation of the knob, even if they are beverage containers having different outer diameters, and thereby improve the convenience of use and the reliability.

### SUMMARY OF THE INVENTION

In order to achieve the above purpose, the present invention is a cup holder, comprising a holding part, which is provided in an opening of a boxlike part having the top side opened and holds a beverage container in a manner so as to sandwich it between inner wall surfaces of the boxlike part, and an auxiliary plate for changing the holding surface, which is disposed on the holding part and can project/withdraw a corresponding part from/into the holding surface side of the holding part by rotational operation by means of a knob, wherein said auxiliary plate projects the corresponding part from only the holding surface on one side of said holding part by rotational operation of said knob in one direction, and projects the corresponding parts from the holding surfaces on both sides of said holding part by rotational operation of said knob in the other direction.

It is preferable that the structure of the above cup holder of the present invention be made concretely in the following manner:

(a) said auxiliary plate is a two-plate structure placed overlapped vertically (second aspect);

(b) by rotational operation of said knob in one direction, one of said auxiliary plates is switched from a stored state overlapped with said holding part to an in-use state projecting the corresponding part from the holding surface on one side of the holding part, and by rotational operation in the other direction, the other one of said auxiliary plates is switched from a stored state overlapped with said holding part to an in-use state projecting the corresponding parts from the holding surfaces on both sides of the holding part (third aspect);

(c) said knob has a first boss and a second boss which enable said knob to switch each said auxiliary plate between said stored state and in-use state (fourth aspect);

(d) one of said auxiliary plates has an arc groove which is provided corresponding to said first boss and a coupling part which is provided inside the groove of said arc groove and couples and releases with said first boss, and when said knob is rotated in one direction in a state having coupled said first boss to said coupling part, it becomes capable of switching said auxiliary plate between said stored state and in-use state, and when it is rotated in the other direction, it releases said coupling part and lets said first boss slip following the arc groove to become capable of idle rotation against the auxiliary plate (fifth aspect);

(e) the other of said auxiliary plates has an arc groove which is provided corresponding to said second boss and a coupling part which is provided inside the groove of the arc groove and couples and releases with said second boss, and when said knob is rotated in the other direction in a state having coupled said second boss to said coupling part, it becomes capable of switching said auxiliary plate between said stored state and in-use state, and when it is rotated in the one direction, it releases said coupling part and lets said second boss slip following the arc groove to become capable of idle rotation against the auxiliary plate (sixth aspect).

In the invention of the first aspect, by rotational operation of the knob in one direction, it projects the corresponding part of the auxiliary plate from one side of the holding part, and by rotational operation of the knob in the other direction, it projects the corresponding parts of the auxiliary plate from both sides of the holding part. Therefore, in all aspects, when both containers are large-diameter containers, when they are small-diameter containers, and when they are large-diameter and small-diameter containers, they can always be held more stably in an optimally held state. Also, because the held state of each mode can be switched easily by rotational operation of the knob, the convenience of use and reliability can be improved.

In the invention of the second aspect, even when using two auxiliary plates, by placing them overlapped vertically, it is not necessary to make the holding part larger and the compactness can be maintained. As opposed to this, in the invention of the third aspect, because each auxiliary plate switched in the same manner between the stored state and the in-use state by forward/backward rotation of the knob, the switching operability can be kept good.

In the inventions of the fourth to sixth aspects, because they are realized with the knob and each auxiliary plate in operational linkage, with a configuration of a first boss and a second boss provided on the knob, and with a configuration of an arc groove and a coupling part provided on each auxiliary plate, it is made such that the mechanical parts can be simplified, whereby they can be implemented while controlling the expense.

### BRIEF DESCRIPTION OF THE DRAWINGS

FIG. 1 is a top view showing the cup holder in a mode of the present invention.

FIG. 2 is a vertical sectional view taken along line 2(a)-2(a) in FIG. 1.

FIG. 3 is an exploded structural drawing showing the related members such as the auxiliary plates relative to the holding member in FIG. 1.

FIGS. 4(a) and 4(b) are plan views of the essential parts showing the relationships of each auxiliary plate to the holding member in FIG. 3.

FIGS. 5(a) and 5(b) show the holding member, wherein FIG. 5(a) is a side view of the holding member, and FIG. 5(b) is a sectional view taken along line 5(b)-5(b) in FIG. 5(a).

FIGS. 6(a) and 6(b) are schematic views showing an operation of the invention, wherein FIG. 6(a) is a side view of the holding member, and FIG. 6(b) is a sectional view taken along line 6(b)-6(b) in FIG. 6(a).

FIGS. 7(a) and 7(b) are drawings for explaining the problem of the conventional cup holder, wherein FIG. 7(a) is a side view, and FIG. 7(b) is a sectional view taken along line 7(b)-7(b) in FIG. 7(a).

### DETAILED DESCRIPTION OF THE EMBODIMENTS

Examples of the present invention are explained while referring to the drawings. In this explanation, the device structure is explained in detail, and then the explanation is made to assembly and operation, and an example of use.

### (Device Structure)

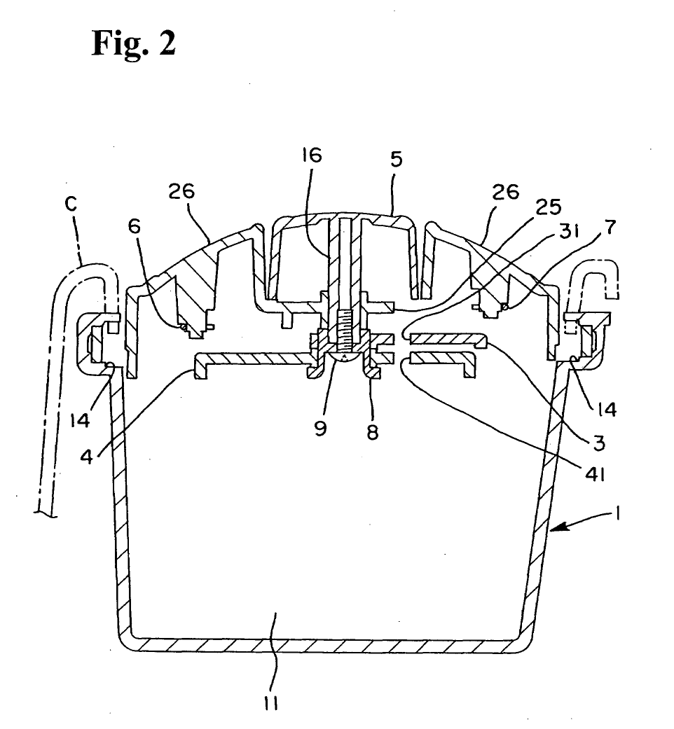

The cup holder of the example, just as in Patent Document 1, comprises a box-like part 1 having the top side opened and a holding tool 2 disposed in the opening of the box-like part 1, and as shown in FIG. 2, it is attached to a part of the center console C of an automobile in an embedded state. Also, the holding tool 2 comprises: a holding member 20 (corresponding to the holding part in the present invention), which holds beverage containers so as to sandwich them between inner wall surfaces 13 and 14 in the front and back of the boxlike part 1; auxiliary plates 3 and 4 for changing the holding surfaces, which are disposed on the underside of the holding member 20 and project/withdraw corresponding/parts of the holding member 20; a knob 5, which switches the auxiliary plates 3 and 4 from a stored state being housed underneath the holding member 20 and an in-use state projecting them from the holding surfaces 21 and 22; and reversing springs 6 and 7, which force the auxiliary plates 3 and 4; and the like. The box-like part 1, holding member 20, auxiliary plates 3 and 4, and knob 5 together are a molded resin product, but it also may be other than resin.

Here, the box-like part 1 extends from the front to back, and it is provided with a partition a small cavity 10 for putting small things in the front and a large cavity 11 for holding beverage containers in the back. The small cavity 10 also may be omitted. The large cavity 11 has a size for two comparatively large-diameter containers, among commercially sold beverage containers, to be inserted and removed. In this example, of the inner wall surfaces that partition the large cavity 11, the arc-shaped inner wall surfaces 12 and 13 positioned in the front and back create spaces to sandwich the beverage containers between them and the sides of the holding tool 2. Also, on the upper edge of both left and right sides from front to back, there are provided guide grooves 14 and 14, facing each other. Each guide groove 14 extends from the front side end of the box-like part 1 to a point which is slightly behind from the middle point of the large cavity 11, and it is designed that the holding member 20 of the holding tool 2 can be built in to slide freely in a fitted-together state.

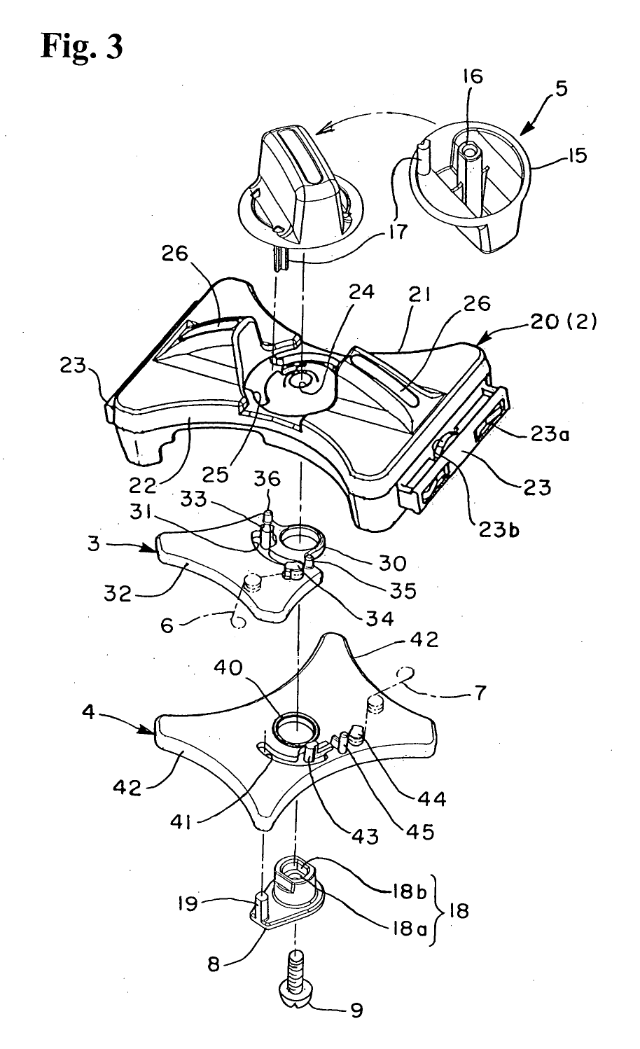

In the holding tool 2, the holding member 20, as shown in FIG. 3, is roughly plate-shaped as a whole, being placed in the width direction of the large cavity 21, the front and back side surfaces 21 and 22 serve as concave arc-shaped holding surfaces to sandwich beverage containers between them and the inner wall surfaces 12 and 13, and it has: fitting parts 23, which are provided on both sides (left and right) and are fitted together with the guide grooves 14; a shaft hole 24, which is punched vertically to be provided in the middle; a restricting groove 25, which is cut out as an arc centered around the shaft hole 24 and restricts the range of rotation of the knob 5; and handles 26, which are projecting to the outside of the arc of the restricting groove 25 and grip the holding member 20 when sliding it following the guide grooves 14. The fitting parts 23 are designed so that the sliding property against the guide grooves 14 is improved by providing elastic projections 23a and 23b on the side surfaces and top surfaces.

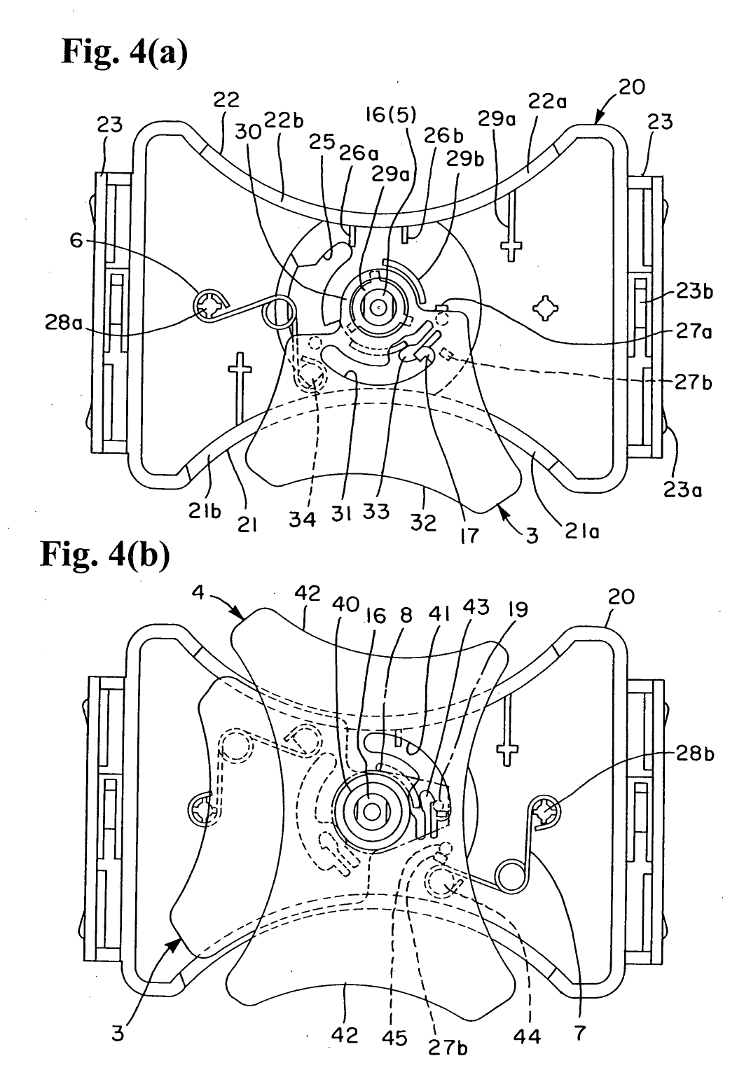

Also, the underside of the holding member 20, as shown in FIG. 4, has: a shallow step 21a for letting the auxiliary plate 4 slip and a deep step 21b for letting the auxiliary plate 3 slip, which are provided on the side surface 21; a shallow step 22a for letting the auxiliary plate 4 slip and a deep step 22b for letting the auxiliary plate 3 slip, which are provided on the side surface 22; catching parts 26a and 27a, which restrict the range of rotation of the auxiliary plate 3; catching parts 26b and 27b, which restrict the range of rotation of the auxiliary plate 4; attachment parts 28a and 28b, which are projecting from both sides and fix one each end of the reversing springs 6 and 7; a center cylindrical part 29a, which forms the shaft hole 24; a guide part 29b, which guides a rotating part on the center side of the auxiliary plate 3; and a reinforcing rib 29c; and the like.

The auxiliary plate 3 is roughly tongue shaped, and it has: a ring-shaped fitting part 30, which is fitted with play onto the cylindrical part 29a; an arc groove 31, which is cut out as an arc around the fitting part 30; a concave arc-shaped holding surface 32, which is formed on the outer perimeter on the side opposite the fitting part 30; an elastic coupling part 33, which is provided inside the groove of the arc groove 31; an attachment part 34, which is respectively placed to project on the top surface and fixes the other end of the reversing spring 6; a projection 35, which contacts with said catching part 26a and locks the auxiliary plate 3 in the stored state; and a projection 36, which contacts with said catching part 27a and locks the auxiliary plate 3 in the in-use state; and the like.

The auxiliary plate 4 has a shape integrating two auxiliary plates 3, and it has: a fitting part 40, which is provided in the middle and corresponds to the fitting part 30; an arc groove 41, which is cut out as an arc centered on the fitting part 40; concave arc-shaped holding surfaces 42 and 42, which are formed on the outer perimeter on both ends centered on the fitting part 40; an elastic coupling part 43, which is provided inside the groove of the arc groove 41; an attachment part 44, which is respectively placed projecting on the top surface and fixes the other end of the reversing spring 7; and a projection 45, which contacts with said catching part 26b and locks the auxiliary plate 4 in the stored state, and contacts with said catching part 27b and locks the auxiliary plate 4 in the in-use state; and the like.

The knob 5 is placed to project on a circular part 15 and has a shape continuing with the handles 26, and it has: a pivot part 16, which is placed to project in the middle on the underside of the circular part 15 and is inserted through said shaft hole 24 and cylindrical part 29a; and a boss 17 (corresponds to the first boss of the present invention), which is placed to project on the outside on the underside of the circular part 15 and is inserted through the restricting groove 25 and the arc groove 31 on the side of the auxiliary plate. The circular part 15 has a size to be placed between said handles 26. The pivot part 16 is non-cylindrical, and it has a female screw formed on the inner diameter of the tip.

Also, the knob 5 has a collar 8, which is connected to the tip of the pivot part 16. This collar 8 has a cylindrical part 18 and a boss 19 (corresponds to the second boss of the present invention) formed on the top surface of a small plate. The cylindrical part 18 includes a center hole 18a, in which the screw 9 is inserted, and a coupling hole 18b, which expands the tip side of the center hole 18a and is coupled with the pivot part 16. The boss 19 is inserted through the arc groove 41 on the side of the auxiliary plate 4.

### (Assembly and Operation)

Next an example of the operation of assembly of each member is explained. First, the auxiliary plate 3 and the reversing spring 6 are attached to the holding member 20 along with the knob 5. In this operation, as shown in FIG. 4(a), the knob 5 is placed on the top of the holding member 20 in a state having the pivot part 16 inserted through the shaft hole 24 and the boss 17 inserted through the restricting groove 25. Next, when the auxiliary plate 3 is rotated up to the in-use state in the same drawing, in a state being on the underside of the holding member 20 and having the fitting part 30 fitted with play onto the cylindrical part 29a and the tip of the boss 17 inserted through the arc groove 31, the boss 17 is elastically coupled to the coupling part 33 provided inside the groove of the arc groove 31. Next, the reversing spring 6 is attached in a state having one end fixed to the attachment part 28a and the other end fixed to the attachment part 34 while accumulating force.

In the above state, the auxiliary plate 3 is switched between the in-use state and the stored state by forward and backward rotational operation (rotational operation in one direction of the present invention) of the knob 5. Because the auxiliary plate 3 is subject to the force of the reversing spring 6 in the in-use state and the stored state, it does not rotate unexpectedly or rattle. Also, when the knob 5 is rotationally operated in the reverse direction (rotational operation in the other direction of the present invention) in opposition to the force of the reversing spring 6 from the stored state of the auxiliary plate 3, the boss 17 is decoupled from the coupling part 33 and is let to slip following the arc groove 31 and it is rotated idly against the auxiliary plate 3.

Next, the auxiliary plate 4 and the reversing spring 7 are attached to the holding member 20 along with the collar 8. In this operation, as shown in FIG. 4(b), for example the auxiliary plate 4 is placed in a state having the fitting part 40 overlaid on the fitting part 30, and after that, the collar 8, in a state having the boss 19 inserted through the arc groove 41, is coupled and connected by (the coupling hole 18b on the tip side of) the cylindrical part 18 through the fitting part 40 and the fitting part 30 onto the tip of the pivot part 16 projecting on the shaft hole 24. Also, when the auxiliary plate 4 is rotated up to the in-use state in the same drawing, the boss 19 is elastically coupled to the coupling part 43 provided inside the groove of the arc groove 41. Next, the reversing spring 7 is attached in a state having one end fixed to the attachment part 28b and the other end fixed to the attachment part 44 while accumulating force.

In the above state, the auxiliary plate 4 is switched between the in-use state and the stored state by forward and backward rotational operation (rotational operation in the other direction of the present invention) of the knob 5. Because the auxiliary plate 4 is subject to the force of the reversing spring 7 in the in-use state and the stored state, it does not rotate unexpectedly or rattle. Also, when the knob 5 is rotationally operated in the reverse direction (rotational operation in the one direction of the present invention) in opposition to the force of the reversing spring 7 from the stored state of the auxiliary plate 4, the boss 19 is decoupled from the coupling part 43 and is let to slip following the arc groove 41, whereby it is rotated idly against the auxiliary plate 4. When the knob 5 is rotationally operated in the reverse direction (rotational operation in the one direction of the present invention), although the auxiliary plate 4 is kept in the stored state, the auxiliary plate 3 comes to be switched from the stored state to the in-use state.

### (Use Example)

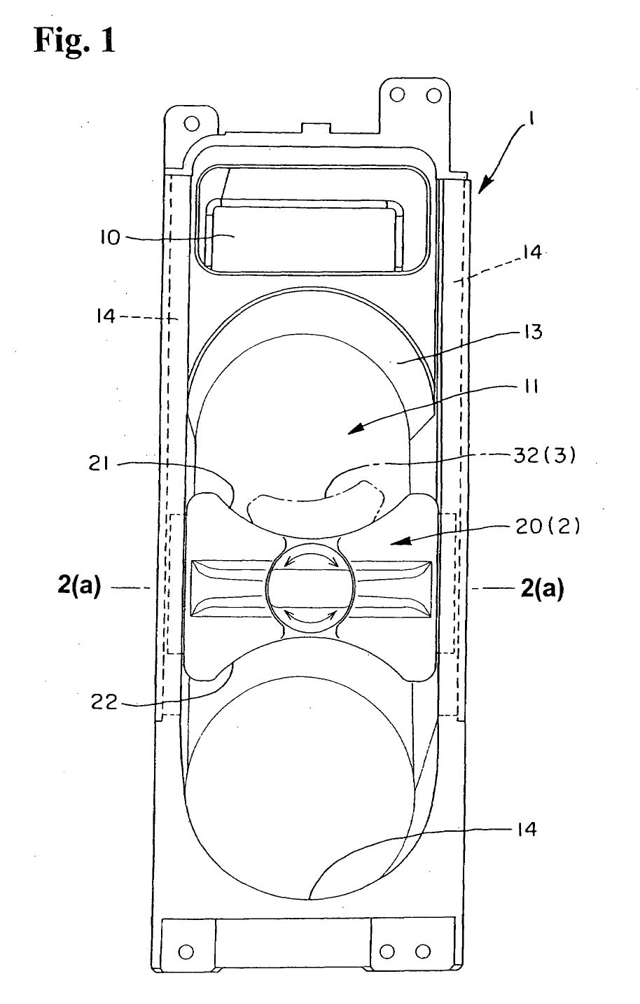

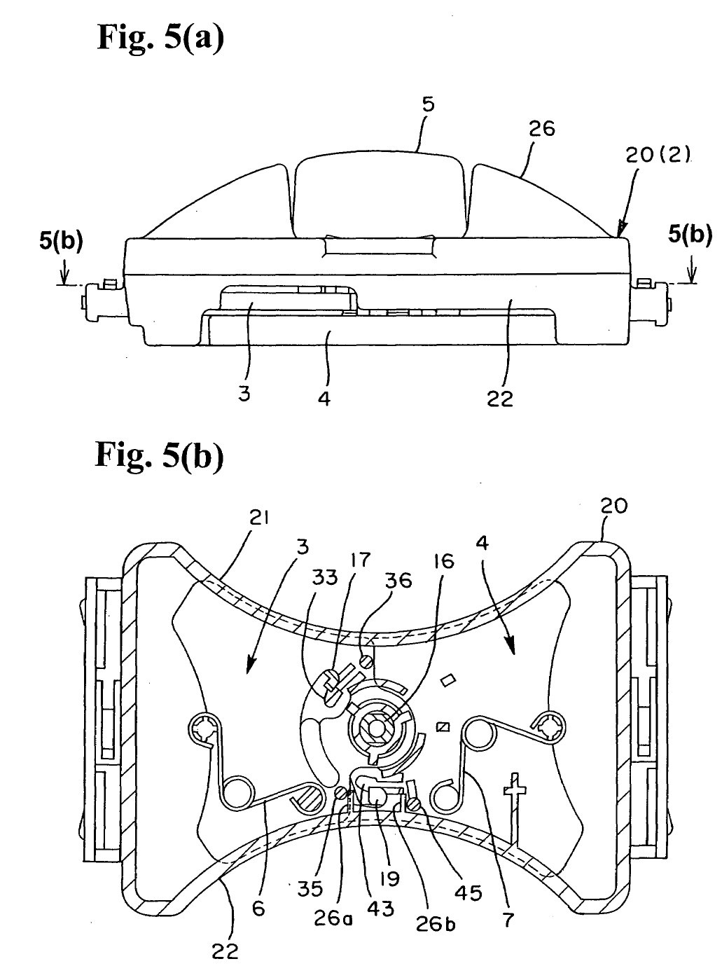

The solid lines in FIG. 1 and FIGS. 5(a) and 5(b) show each auxiliary plate 3 and 4 in the stored state being housed underneath the holding member 20. At this time, two large-diameter containers can be held in a stable state in the space between the holding surface 21 of the holding member 20 and the inner wall surface 13 and in the space between the holding surface 22 of the holding member 20 and the inner wall surface 14. In this mode, because each auxiliary plate 3, 4 is kept in the stored state by being subject to the force of the reversing springs 6 and 7, it does not rattle or be rotated unexpectedly even when being subject to vibration. Of course, in this structure, the space between the holding surface 21 and the inner wall surface 13 and the space between the holding surface 22 and the inner wall surface 14 can be changed by sliding the holding tool 2 (holding member 20) forward and backward following the guide groove 14 against the box-like body 1.

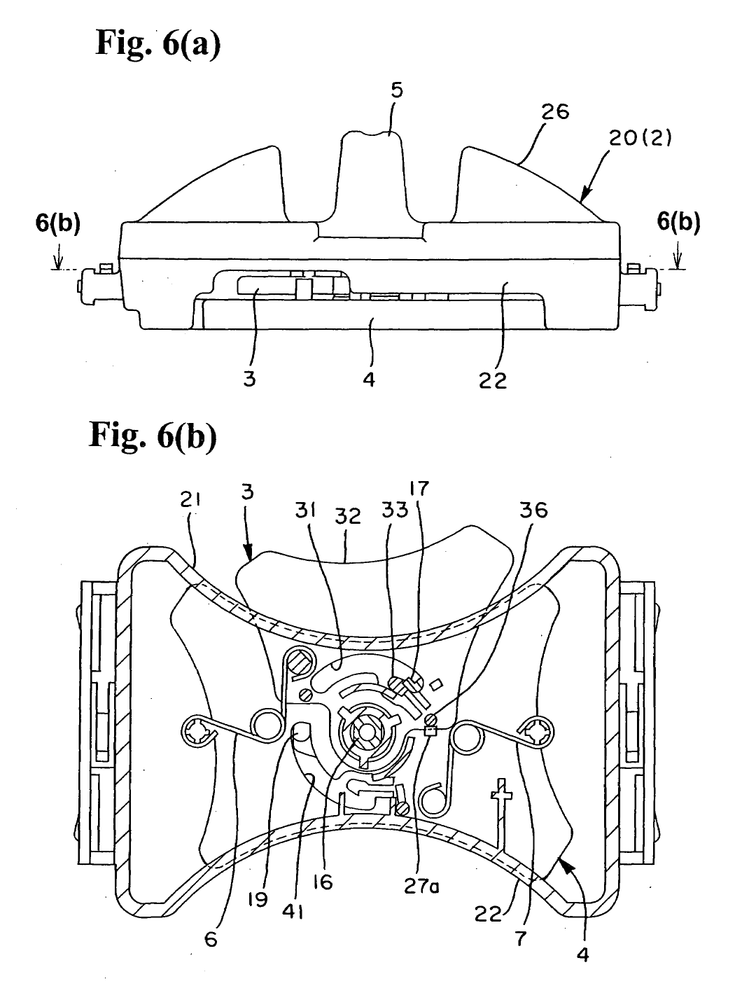

The imaginary lines in FIG. 1 and FIGS. 6(a) and 6(b) show the auxiliary plate 3 in the in-use state and the auxiliary plate 4 in the stored state being housed underneath the holding member 20. At this time, a small-diameter container can be held in a stable state in the space between the holding surface 32 of the auxiliary plate 3 and the inner wall surface 13, and a large-diameter container also can be held in a stable state in the space between the holding surface 22 and the inner wall surface 14. In this mode also, because the auxiliary plate 3 is kept in the in-use state by being subject to the force of the reversing spring 7 and the auxiliary plate 4 is kept in the stored state by being subject to the force of the reversing spring 7, it does not rattle or be rotated unexpectedly even when being subject to vibration.

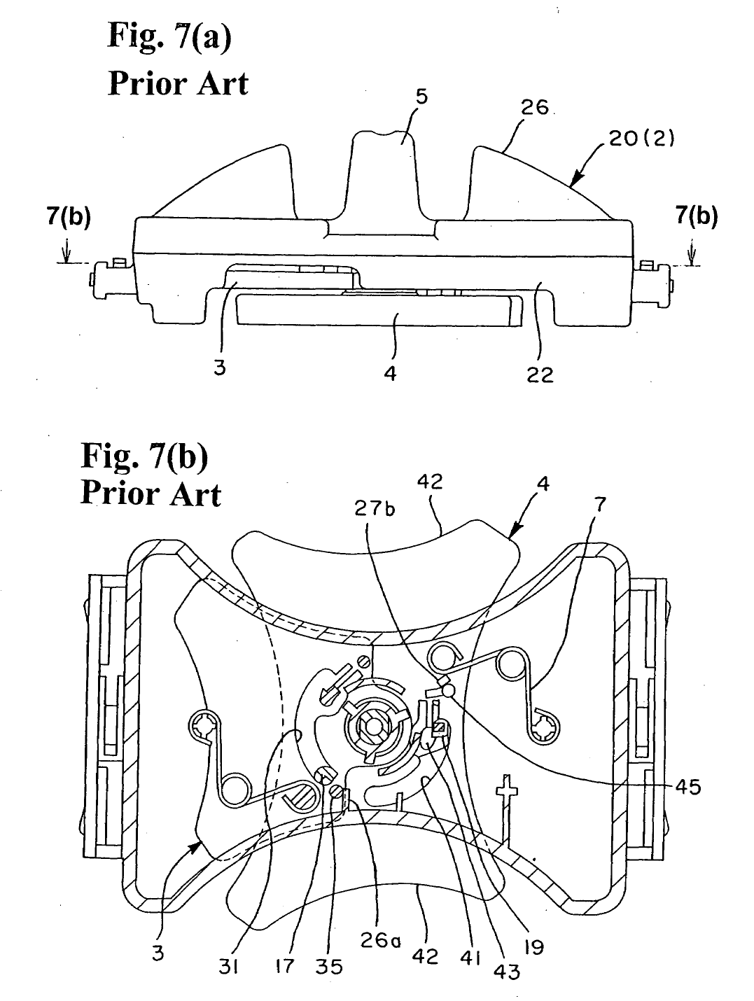

FIGS. 7(a) and 7(b) show the auxiliary plate 4 in the in-use state and the auxiliary plate 3 in the stored state being stored underneath the holding member 20. At this time, two small-diameter containers can be held in a stable state in the space between the holding surface 42 of the auxiliary plate 4 and the inner wall surface 13 and in the space between the holding surface 42 of the auxiliary plate 4 and the inner wall surface 14. In this mode also, because the auxiliary plate 3 is kept in the stored state by being subject to the force of the reversing spring 7 and the auxiliary plate 4 is kept in the in-use state by being subject to the force of the reversing spring 7, it does not rattle or be rotated unexpectedly when being subject to vibration. Of course, in this state also, it becomes possible to change the space between the holding surface 42 and the inner wall surface 13 and the space between the holding surface 42 and the inner wall surface 14 by sliding the holding tool 2 (holding member 20) forward and backward following the guide groove 14 against the boxlike body 1.

The above modes do not restrict the present invention in any way. The present invention can be modified variously based on these mode examples except for the essential conditions specified in the first aspect of the invention. As one example of that, as a configuration of the auxiliary plate 3 (or auxiliary plate 4), the part including the holding surface 32 (holding surface 42) is divided from the auxiliary plate 3 (or auxiliary plate 4). Also, the divided part, for example, referring to the holding member, and the like, in Japanese Unexamined Patent Publication No. 2003-237451, is connected to be capable of tilting downward from a horizontal state by means of a hinge on a corresponding part of the auxiliary plate after division, and it is forced to become on a plane with the auxiliary plate by a forcing means. Also, in the in-use state of the auxiliary plate, it is made such that the divided part is tilted according to the outer diameter of the container.

What is claimed is:

1. A cup holder, comprising:
a holding part provided in an opening of a box-like part having a top side opened and holding a beverage container in a manner so as to sandwich it between inner wall surfaces of the box-like part, and
an auxiliary plate disposed on the holding part for changing a holding surface to able to project/withdraw a corresponding part from/into a holding surface side of the holding part by rotational operation through a knob,
wherein the auxiliary plate projects a corresponding part from only the holding surface on one side of the holding part by rotational operation of said knob in one direction, and projects corresponding parts from the holding surfaces on two sides of the holding part by rotational operation of said knob in other direction.

2. The cup holder according to claim 1, wherein said auxiliary plate is a two-plate structure placed to overlap vertically.

3. The cup holder according to claim 2, wherein by the rotational operation of said knob in one direction, one of said auxiliary plates is switched from a stored state overlapping with said holding part to an in-use state projecting the corresponding part from the holding surface on one side of the holding part, and by the rotational operation in the other direction, other one of said auxiliary plates is switched from a stored state overlapping with said holding part to an in-use state projecting the corresponding parts from the holding surfaces on two sides of the holding part.

4. The cup holder according to claim 3, wherein said knob has a first boss and a second boss which enable said knob to switch each said auxiliary plate between said stored state and in-use state.

5. The cup holder according to claim 4, wherein one of said auxiliary plates comprises:
an arc groove provided corresponding to said first boss and,
a coupling part provided inside a groove of said arc groove and coupling and releasing with said first boss,
wherein when said knob is rotated in one direction in a state having coupled said first boss to said coupling part, it becomes capable of switching said auxiliary plate between said stored state and in-use state, and when it is rotated in the other direction, it releases said coupling part and lets said first boss slip following the arc groove to become capable of idle rotation against the auxiliary plate.

6. The cup holder according to claim 5, wherein the other one of said auxiliary plates comprises:
an arc groove provided corresponding to said second boss, and
a coupling part provided inside a groove of the arc groove and coupling and releasing with said second boss,
wherein when said knob is rotated in the other direction in a state having coupled said second boss to said coupling part, it becomes capable of switching said auxiliary plate between said stored state and in-use state, and when it is rotated in the one direction, it releases said coupling part and lets said second boss slip following the arc groove to become capable of idle rotation against the auxiliary plate.
